(19) United States
(12) Patent Application Publication
(10) Pub. No.: US 2007/0075602 A1
(43) Pub. Date: Apr. 5, 2007

(54) DC motor and manufacturing method for the same

(76) Inventors: Yoshiki Nakano, Hamamatsu-shi (JP); Masayuki Kuwano, Kosai-shi (JP); Kazumitsu Moriya, Kosai-shi (JP); Toshio Yamamoto, Kosai-shi (JP)

Correspondence Address: PEARL COHEN ZEDEK LATZER, LLP, 1500 BROADWAY 12TH FLOOR, NEW YORK, NY, 10036, US

(21) Appl. No.: 11/528,629

(22) Filed: Sep. 28, 2006

(30) Foreign Application Priority Data
Jul. 7, 2006 (JP) 2006/188099
Sep. 30, 2005 (JP) 2005/288246

(51) Int. Cl. H02K 23/04; H02K 21/26

(52) U.S. Cl. 310/154.21; 310/154.22; 310/154.08

(57) ABSTRACT

A DC motor is provided with a yoke having a polygonal cylindrical shape and an inner wall surface provided with a plurality of consecutive flat surfaces, a plurality of permanent magnets each having a flat plate shape, being fixed on each flat surface on the inner wall surface of the yoke, and an armature arranged rotatably within the yoke. Each permanent magnet has a surface facing the armature. The surface has a rectangle shape provided with a symmetry center. Each permanent magnet is asymmetrical with respect to a line passing through the symmetry center and extending in an axial direction of the yoke. Accordingly, a dimension along the axial direction of the yoke in each permanent magnet decreases toward the outer side from a center part of the permanent magnet.

### PRIOR APPLICATION DATA

The present application claims priority from Japanese Patent Application No. 2006/188099, filed on Jul. 7, 2006, and Japanese Patent Application No. 2005/288246, filed on Sep. 30, 2005, all of which are incorporated by reference in their entirety.

### FIELD OF THE INVENTION

The present invention relates to a DC motor and a manufacturing method for the same.

### BACKGROUND OF THE INVENTION

There is disclosed a DC motor provided with a stator and an armature arranged inside the stator in Japanese Laid-Open Patent Publication No. 2005-20914. The stator has a polygonal cylindrical shape and is provided with an inner wall formed by consecutive flat surfaces and permanent magnets fixed on the respective flat surfaces of the inner wall surface of the yoke. In such a DC motor, deformation of the yoke caused by magnetic fluctuation at the time of the armature rotation is unlikely to occur, so that vibration of the motor caused by deformation of the yoke is prevented.

Each permanent magnet has a surface facing the armature. The surface of each permanent magnet has a circular-arc-shape warped outwardly of the permanent magnet toward a center part from both ends along the yoke. Further, the armature is provided with an outer circumferential surface with a circular-arc-shape. A curvature radius of the circular arc of the surface of the each permanent magnet is set larger than the curvature radius of the circular arc of the outer circumferential surface of the armature. The permanent magnet is formed such that a space between the permanent magnet and the armature in the radial direction of the armature increases toward both sides from the center part. For this reason, in both sides of the permanent magnet, cogging torque decreases because rapid magnetic flux change between the permanent magnet and the armature decreases. Vibration of the motor is suppressed, accordingly.

However, also in the above described DC motor, cogging torque is not lost. Thus, it is desired to further decrease cogging torque easily with a simple construction.

### SUMMARY OF THE INVENTION

It is an objective of the present invention to provide a DC motor and a manufacturing method of the same capable of achieving further decrease of cogging torque easily with a simple construction.

To achieve the foregoing objective and in accordance with one aspect of the present invention, a DC motor including a yoke, a plurality of permanent magnets, and an armature is provided. The yoke has a polygonal cylindrical shape and an inner wall surface provided with a plurality of consecutive flat surfaces. The permanent magnets each have a flat plate shape and are fixed on the respective flat surfaces in the inner wall surface of the yoke. The armature is arranged rotatably within the yoke. A dimension of each magnet along an axial direction of the yoke decreases toward an outer side from a center part of the permanent magnet.

In accordance with a second aspect of the present invention, a DC motor including a yoke, an armature, and a plurality of permanent magnets is provided. The yoke has a polygonal cylindrical shape and an inner wall surface provided with a plurality of consecutive flat surfaces. The armature is arranged rotatably within the yoke. The permanent magnets each have a flat plate shape and are fixed on the respective flat surfaces in the inner wall surface of the yoke. Each permanent magnet has a surface facing the armature, and the surface has a polygonal shape provided with a center of symmetry (“symmetry center”) or an oval shape. Each of the permanent magnets is asymmetrical with respect to a line passing through the symmetry center and extending in an axial direction of the yoke.

In accordance with a third aspect of the present invention, a method for manufacturing a DC motor is provided. The DC motor comprises a yoke having a polygonal cylindrical shape and having an inner wall surface provided with a plurality of consecutive flat surfaces, an armature arranged rotatably within the yoke, and a plurality of permanent magnets each having a flat plate shape fixed on the respective flat surfaces in the inner wall surface of the yoke. Each permanent magnet has a surface facing the armature, and the surface has a polygonal shape provided with a symmetry center or an oval shape. Each permanent magnet is asymmetrical with respect to a line passing through the symmetry center and extending in an axial direction of the yoke. The method includes: fixing temporarily each of the permanent magnets magnetized on each flat surface in an inner wall surface of the yoke by own magnetic force; measuring motor characteristics including cogging torque; rotating the permanent magnets with the symmetry center as a rotation center on the flat surface in the inner wall surface of the yoke when the motor characteristics measured are deviated from a value set preliminarily; and fixing each of the permanent magnets on each of the flat surfaces in the inner wall surface of the yoke with an adhesive.

Further, in accordance with a fourth aspect of the present invention, a DC motor including a yoke and an armature is provided. The yoke has a cylindrical shape and an inner wall surface. The armature is arranged inside the yoke, and includes an armature core, a commutator, and eight coils. The armature core has a cylindrical shape provided with an outer circumferential surface, and eight teeth radially extending from the outer circumferential surface. The commutator has twenty-four segments and is arranged on an inner side of the armature core. The coils are wound around the respective teeth with concentrated-winding. Each coil is connected to at least one of the segments. The coils are connected in such a way as to constitute one closed loop. The DC motor further includes an anode side power supply brush, a cathode side power supply brush, a plurality of magnets, and a center axis. The anode side power supply brush and the cathode side power supply brush each come into a slidable contact with at least one of the segments of the commutator. The brushes cause the armature to rotate by supplying drive supply power for the armature through the commutator. The magnets each have a flat plate shape and are set on the inner wall surface of the yoke with equiangular intervals. Each magnet includes a surface facing the armature, and a magnetic flux extending in a direction perpendicular to the surface. On the surface of each magnet, an angle constituted by a pair of line segments connecting both ends in a direction perpendicular to the axial direction of the yoke to the center axis is set to 34.5 degrees to 52 degrees.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross sectional view of a DC motor according to a first embodiment, viewed from its axial direction;

FIG. 2 is a cross sectional view of a stator viewed from a direction perpendicular to the axis of a yoke;

FIG. 3 is a view for explaining a permanent magnet;

FIG. 4 is a graph for explaining the relationship between an open angle of the permanent magnet, and cogging torque, and the amount of magnetic flux;

FIG. 5 is a cross sectional view of a DC motor according to a second embodiment, viewed from its axial direction;

FIG. 6 is a view for explaining a magnet;

FIG. 7A is a development view showing an electrical constitution for the motor;

FIG. 7B is a circuit diagram showing a connection state of a coil;

FIG. 8 is a schematic view of the yoke developed according to a first modification;

FIG. 9 is a cross sectional view of a stator viewed from a direction perpendicular to the axis of the yoke according to a second modification;

FIG. 10 is a cross sectional view of the stator viewed from a direction perpendicular to the axis of the yoke according to a third modification;

FIG. 11 is a cross sectional view of the stator viewed from a direction perpendicular to the axis of the yoke according to a fourth modification;

FIG. 12 is a cross sectional view of the stator viewed from a direction perpendicular to the axis of the yoke according to a fifth modification; and

FIG. 13 is a cross sectional view of the stator viewed from a direction perpendicular to the axis of the yoke according to a sixth modification.

### DETAILED DESCRIPTION OF THE INVENTION

### First Embodiment

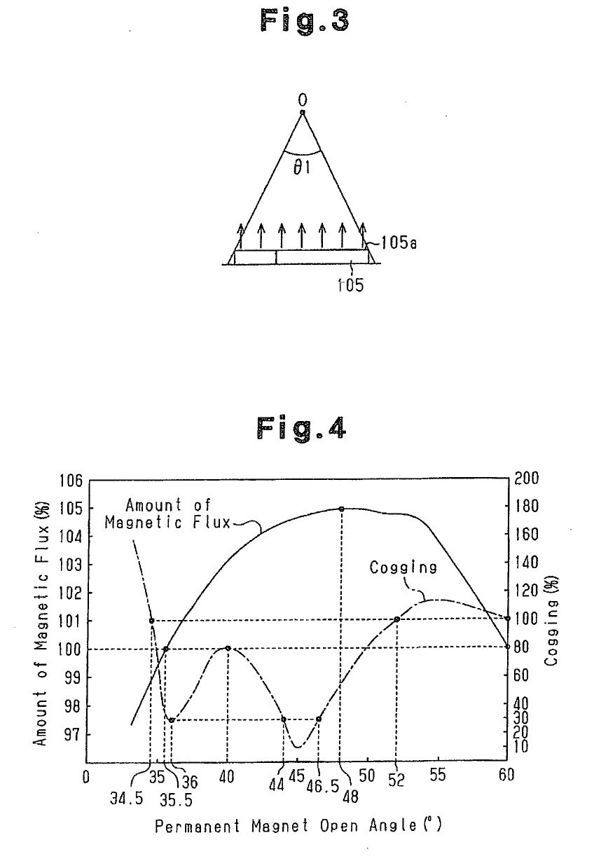

Hereinafter, there will be described a first embodiment of the invention in accordance with FIGS. 1 to 4. As shown in FIG. 1, a DC motor 101 of the present embodiment is provided with a stator 102 and an armature 103 rotating relative to the stator 102. The stator 102 of the present embodiment is provided with a yoke 104 having a hexagonal cylindrical shape for a polygonal cylindrical shape, and six permanent magnets 105 with flat plate shape. The yoke 104 has an inner wall formed of consecutive flat surfaces. The respective permanent magnets 105 are fixed on the respective flat surfaces in the inner wall surfaces of the yoke 104, and juxtaposed with an equal angular interval each other. The permanent magnets 105 of the present embodiment are each formed of a neodymium magnet. In FIG. 3, as shown by a plurality of arrow marks, the respective permanent magnets 105 are magnetized to generate the magnetic flux which extends in the direction perpendicular to a surface 105a facing the armature 103. For this reason, each permanent magnet 105 has an N pole or an S pole on a fixed surface fixed to the inner wall of the yoke 104 and on the surface 105a. Further, the surfaces 105a of each neighboring pair of the permanent magnets 105 have different poles from each other. As shown in FIG. 1, within the yoke 104 (permanent magnets 105) in the stator 102, the armature 103 is accommodated so as to be rotatable.

The armature 103 is provided with a rotary shaft 106, armature core 107 fixed to the rotary shaft 106, and eight pieces of coils M1 to M8. The armature core 107 has eight pieces of teeth T1 to T8 radially extending from its outer circumferential surface. The respective coils M1 to M8 are wound around on the respective teeth T1 to T8 through concentrated-winding. Between the respective teeth T1 to T8, slots S1 to S8 are formed. The DC motor 101 has a center axis O at the center of the rotary shaft 106.

There is provided a commutator 108 fixed to the rotary shaft 106 in the armature 103. On an outer circumferential surface of the commutator 108, twenty-four segments 1 to 24 are juxtaposed along the circumferential direction of the commutator 108. In the segments 1 to 24 of the commutator 108, for instance, such as a group of the segments 1, 9, 17 or a group of the segments 5, 13, 21, the segments arranged in every seven pieces, that is, arranged at 120 degrees intervals are short circuited for the same potential. The coils M1 to M8 are connected such that the coils arranged in every two pieces along the circumferential direction of the armature 103 are connected to form one closed loop. An anode side power supply brush and a cathode side power supply brush, both not shown in the drawings, arranged with 180 degrees interval are capable of coming into slidable contact with the segments 1 to 24 of the commutator 108. The respective power supply brushes supply power to the armature 103 (coils M1 to M8) through the commutator 108 based on the power supplied from the outside part, causing the DC motor 101 (rotary shaft 106) to be rotated and driven.

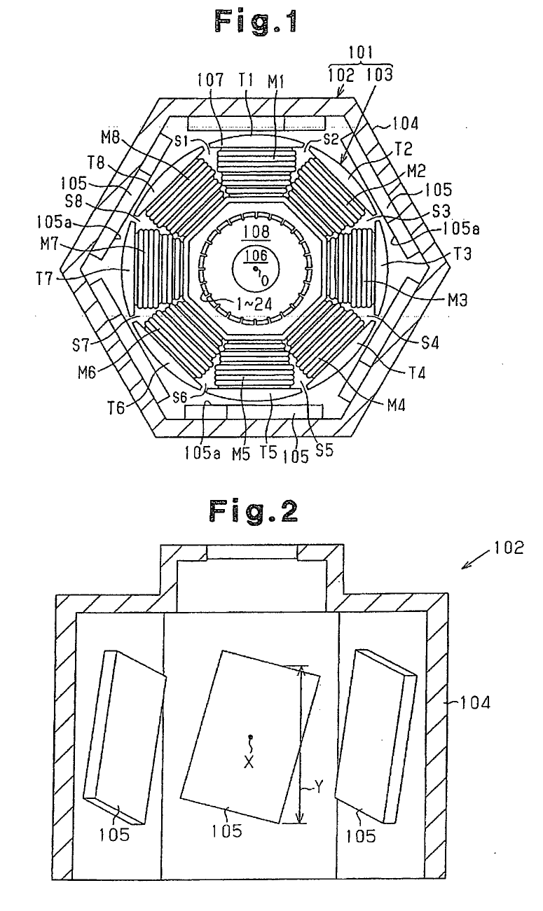

As shown in FIG. 2, in the respective permanent magnet 105 of the present embodiment, dimension Y along the axial direction of the yoke 104 decreases toward the outer side from the center part of the respective permanent magnets 105. Specifically, in each permanent magnet 105, the surface 105a has a polygonal shape with a symmetry center or an oval shape. In the present embodiment, the surface 105a has a rectangular shape provided with a symmetry center X and four sides. The respective permanent magnets 105 are asymmetrical with respect to a line passing through the symmetry center X and extending to the axial direction of the yoke 104. That is, in the present embodiment, the respective permanent magnets 105 are arranged such that the respective sides of the surface 105a are inclined with respect to the axis of the yoke 104. According to the above structure, the dimension Y of the respective permanent magnets 105 decreases toward the outer side from the center part of the respective permanent magnets 105. In the respective permanent magnets 105, the respective sides of the surface 105a are inclined with the same tilt angle to the axis of the yoke 104, and the whole permanent magnets 105 are arranged in such a way as to be inclined in the same direction.

The inventors have investigated with respect to the dimension Y of the permanent magnet 105 in the DC motor 101 having the above described constitution. Specifically, as shown in FIG. 3, the inventors have investigated, in the surface 105a of the permanent magnet 105, an angle (center angle) θ1 constituted by a pair of line segments connecting both ends in the direction perpendicular to the axis of the yoke 104 to the center axis O of the motor 101. In the following description, the angle θ1 is referred to as an open angle θ1 of the permanent magnets 105. From the fact that the number of the permanent magnets 105 used in the present embodiment is six, the maximum value of the open angle θ1 in the individual permanent magnet 105 is 60 degrees. In the case that the open angle θ1 of the permanent magnets 105 is 60 degrees as being the maximum value, that is, in the case that the respective permanent magnets 105 are arranged in the circumferential direction of the yoke 104 without any gap, the amount of magnetic flux and the value of cogging torque are set to 100%. Then, the amount of magnetic flux and the value of cogging torque change as shown in FIG. 4 with changing the open angle θ1 of the respective permanent magnets 105.

Specifically, when the open angle θ1 of the permanent magnets 105 increases from the vicinity of 34 degrees, cogging torque decreases, accordingly. When the θ1 is 34.5 degrees, cogging torque becomes 100% or less. When the θ1 is 36 degrees, cogging torque becomes 30%. When the open angle θ1 of the permanent magnets 105 exceeds 36 degrees, cogging torque increases once until θ1 becomes 40 degrees. When the θ1 is 40 degrees, cogging torque becomes 80%. When the open angle θ1 of the permanent magnets 105 exceeds 40 degrees, cogging torque decreases again until the θ1 becomes 45 degrees.

When the open angle θ1 of the permanent magnets 105 becomes 45 degrees, cogging torque becomes 10%, the minimum value, when the θ1 exceeds 45 degrees, cogging torque increases again. At this time, when the open angle θ1 of the permanent magnets 105 is in the range of from 44 degrees to 46.5 degrees, cogging torque becomes 30% or less. When the open angle θ1 of the permanent magnets 105 becomes 52 degrees, cogging torque exceeds 100%. After that, cogging torque increases once together with increase of the open angle θ1 of the permanent magnets 105, thereafter cogging torque decreases. When the θ1 is 60 degrees, cogging torque becomes 100%.

On the other hand, when the open angle θ1 of the permanent magnets 105 increases from the vicinity of 34 degrees, the amount of magnetic flux increases, accordingly. When the θ1 is 35.5 degrees, the amount of magnetic flux exceeds 100%. When the open angle θ1 of the permanent magnets 105 becomes 48 degrees, the amount of magnetic flux becomes 105%, or the maximum value. When the θ1 is 48 degrees; the amount of magnetic flux starts to decrease. Then, when the open angle θ1 of the permanent magnets 105 becomes 60 degrees, the amount of magnetic flux becomes 100%.

Based on the investigation result, it has been found that with respect to the open angle θ1 of the permanent magnets 105, the range of 34.5 degrees to 52 degrees is a good range where cogging torque decreases to 100% or less, and the range of 35.5 degrees to 52 degrees is a better range where cogging torque decreases and the amount of magnetic flux exceeds 100%. Further, it has been found that the range of 40 degrees to 52 degrees is an excellent range where cogging torque decreases and high level amount of magnetic flux including the maximum value can be obtained. Among these ranges, when the open angle θ1 of the permanent magnets 105 is within the range of 44 degrees to 46.5 degrees, it is possible to obtain the amount of magnetic flux with high level close to the maximum value, and it is possible to decrease cogging torque remarkably (to the lowest level). For this reason, with respect to the open angle θ1 of the permanent magnets 105, it is found that the range of 44 degrees to 46.5 degrees is desirable range from the viewpoint of decreasing cogging torque.

Based on the above matters, in the DC motor 101 of the present embodiment, from the open angle θ1 of the permanent magnets 105 described above, a distance of both ends in the direction perpendicular to the axial direction of the yoke 104 in the surface 105a of the permanent magnet 105 (length in the width direction of each permanent magnet 105) and the tilt angle of the permanent magnet 105 are set, so that the decrease of cogging torque and the increase of the amount of magnetic flux are achieved. Accordingly, in the present embodiment, there is achieved realization of a low vibration and realization of a high output of the DC motor 101. The open angle θ1 of the permanent magnets 105 of the present embodiment, according to the above reason, preferably is set to 34.5 degrees to 52 degrees, more preferably is set to 35.5 degrees to 52 degrees, more preferably it is set to 40 degrees to 52 degrees, and the most preferably it is set to 44 degrees to 46.5 degrees.

A manufacturing method of the above described DC motor 101 is provided with “a temporary fixing process”, “a measuring process”, “an adjusting process” and “a fixing process”. Specifically, in “the temporary fixing process”, the respective magnetized permanent magnets 105 are temporarily fixed on the respective flat surfaces in the inner wall surface of the yoke 104 due to their own magnetic force. In “the measuring process”, motor characteristics including cogging torque are measured. In “the adjusting process”, when the motor characteristics as measured deviate from the value set preliminarily, in the flat surface on the inner wall surface of the yoke 104, the permanent magnets 105 are rotated with the symmetry center X as the rotational center. That is, the tilt angle of the permanent magnets 105 is changed. For instance, in the motor characteristics measured, when cogging torque is larger than the value set preliminarily, the permanent magnets 105 are rotated so that the tilt angle becomes large. Additionally, the motor characteristics measured agree with the value set beforehand, “the adjusting process” is not carried out. After “the measuring process” or “the adjusting process”, the permanent magnets 105 are fixed (secured) on the respective flat surfaces in the inner wall surfaces of the yoke 104 with an adhesive such that the motor characteristics agree with the value set preliminarily. In such a way, the stator 102 of the DC motor 101 is manufactured.

The present embodiment has the following advantages.

(1) The stator 102 is provided with the yoke 104 having a polygonal cylindrical shape and the permanent magnets 105 each having a flat plate shape and fixed on the respective flat surface of the inner wall surface of the yoke 104. Accordingly, the distance between each permanent magnet 105 and the armature 103 in the radial direction of the armature 103 increases toward the outer side from the center part of the permanent magnet 105. As a result, in the permanent magnet 105, a sudden change of the magnetic flux between the permanent magnet 105 and the armature 103 in the outer side decreases, so that cogging torque decreases.

Further, the permanent magnet 105 has the flat plate shape, and the dimension Y decreases toward the outer side from the center part of the permanent magnet 105. Therefore, a sudden change of the magnetic flux further decreases between the permanent magnet 105 and the armature 103 at the outer side of the permanent magnet 105 easily with a simple constitution, so that it is possible to further decrease cogging torque.

(2) In the respective permanent magnets 105, the surface 105a has the rectangle shape provided with the symmetry center X. Further, the respective permanent magnets 105 are asymmetrical with respect to a line passing through the symmetry center X and extending in the axial direction of the yoke 104. Accordingly, the dimension Y of the permanent magnet 105 decreases toward the outer side from the center part of the permanent magnet 105. Therefore, it is possible to obtain the effect described in the above (1) easily with a simple constitution. Further, in this constitution, when the permanent magnets 105 rotate with the symmetry center X as the rotational center, the motor characteristics including cogging torque change. Thereby, it becomes possible to easily perform adjustment of motor characteristics.

(3) In the present embodiment, the six permanent magnets 105 are arranged in equiangular intervals. The surface 105a of each permanent magnet 105 has a rectangle shape provided with four sides. Then, the permanent magnets 105 are arranged such that the respective sides of the surface 105a are inclined relative to the axis of the yoke 104. The open angle θ1 of the permanent magnets 105 is preferably set to 34.5 degrees to 52 degrees. A relationship between the open angle θ1 of the permanent magnets 105 and cogging torque is investigated (see FIG. 4). According to the result of the investigation, in this region, cogging torque decreases in comparison with the state when the open angle θ1 of the permanent magnets 105 is 60 degrees, that is, when the permanent magnets 105 are arranged in the axial direction of the yoke 104 without any gap. Further, according to the results (see FIG. 4) in which relationship between the open angle θ1 of the permanent magnets 105 and cogging torque is investigated, when the open angle θ1 of the permanent magnets 105 is set to 44 degrees to 46.5 degrees, cogging torque decreases greatly, and it is possible to obtain the amount of magnetic flux sufficiently with a high level close to the maximum value.

(4) In the above manufacturing method for the DC motor 101, the motor characteristics including cogging torque are measured in “the measuring process”, and in the case that the motor characteristics measured deviate from the value set preliminarily, the permanent magnets 105 are rotated in “the adjusting process”. Accordingly, it is possible to obtain a DC motor 101 with preferable motor characteristics including cogging torque.

### Second Embodiment

Hereinafter, there will be described a second embodiment embodying the present invention in accordance with FIGS. 5 to 8. In the following descriptions, with reference to the members identical to those of the first embodiment, like symbols are given with its description omitted.

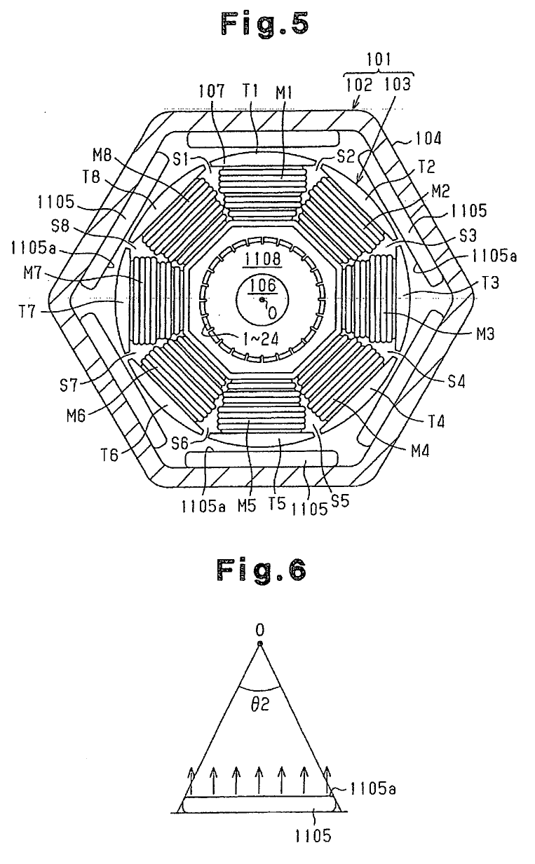

As shown in FIG. 5, a DC motor 101 of the present embodiment is provided with a stator 102 and an armature 103 to rotate relative to the stator 102. The stator 102 of the present embodiment is provided with a yoke 104 having a hexagonal cylindrical shape, and six magnets 1105 with flat plate shape. The respective magnets 1105 are fixed on the respective flat surfaces in the inner wall surface of the yoke 104, and juxtaposed each other with an equiangular interval. The magnets 1105 of the present embodiment are formed of neodymium magnets. In FIG. 6, as shown in a plurality of arrow marks, the respective magnets 1105 are magnetized such that the magnetic flux is generated which extends in the direction perpendicular to the surface 1105a facing the armature 103. For this reason, each magnet 1105 has an N poles or S pole on a fixed surface fixed to the inner wall of the yoke 104, the surfaces 1105a. Further, the surfaces 1105a of neighboring magnets 1105 have different poles with respect to each other.

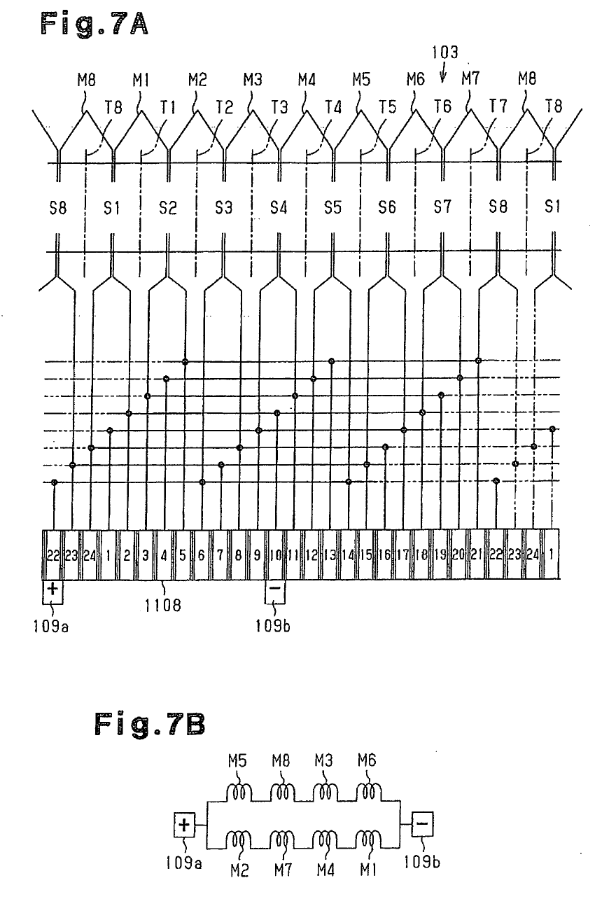

The armature 103 is provided with a commutator 1108 fixed to the rotary shaft 106 in the armature 103. On an outer circumferential surface of the commutator 1108, twenty-four segments 1 to 24 are juxtaposed along the circumferential direction of the commutator 1108. As shown in FIG. 7A, both terminals of the coil M1 are connected to the neighboring segments 2, 3 respectively. Both terminals of the coil M2 are connected to the neighboring segments 5, 6 with one segment 4 left relative to the segments 2, 3 to which the coil M1 is connected. Both terminals of the coil M3 are connected to the neighboring segments 8, 9 with one segment 7 left relative to the segments 5, 6 to which the coil M2 is connected. In such a way, the respective coils M1 to M8 are connected to the corresponding segments respectively. Further, in the segments 1 to 24 of the commutator 1108, for instance, such as a group of the segments 1, 9, 17 or a group of the segments 5, 13, 21, the segments arranged in every seven pieces, that is, arranged 120-degree intervals are short circuited for the same potential. As shown in FIG. 7B, the coils M1 to M8 are connected so as to constitute one closed loop.

An anode side power supply brush 109a and a cathode side power supply brush 109b arranged with 180 degrees interval and faced by sandwiching the rotary shaft 106 come into slidable contact with the segments 1 to 24 of the commutator 1108. The respective power supply brushes 109a, 109b supply power to the armature 103 (coils M1 to M8) through the commutator 1108 based on the power supplied from the outside part, and cause the DC motor 101 (rotary shaft 106) to be rotated and driven.

The inventors have considered the length of the width direction of each magnet 1105 in the DC motor 101 having the constitution described as above. Specifically, as shown in FIG. 6, in the surface 1105a of the magnet 1105, the inventors have considered an angle (center angle) θ2 constituted by a pair of line segments connecting both ends in the direction perpendicular to the axial direction of the yoke 104 with the center axis O of the motor 101. In the following description, the angle θ2 is referred to as an open angle θ2 of the magnets 1105. As a result, also as for the open angle θ2 of the magnets 1105, there has been obtained the same result as the open angle θ1 of the permanent magnets 105 of the first embodiment shown in FIG. 4.

Basis on the above, in the DC motor 101 of the present embodiment, the open angle θ2 of the magnets 1105 is set to 34.5 degrees to 52 degrees, preferably 35.5 degrees to 52 degrees, more preferably 40 degrees to 52 degrees, and the most preferably 44 degrees to 46.5 degrees. Accordingly, there is achieved decrease of cogging torque and increase of the amount of magnetic flux, and there is achieved realization of low vibration and realization of high output of the DC motor 101.

The present embodiment has the following advantages.

(5) In the present embodiment, the magnet 1105 has the flat plate shape, and is magnetized such that the magnetic flux extends in the direction perpendicular to the surface 1105a to the armature 103. Then, the magnets 1105 are juxtaposed at equal angular intervals on the inner surface of the yoke 104. The relationship between the open angle θ2 of the magnets 1105, and cogging torque and the amount of magnetic flux of this case has been investigated. As a result, in the present embodiment, the dimension of the magnets 1105 is set such that the open angle θ2 of the magnets 1105 becomes 34.5 degrees to 52 degrees. Therefore, it is possible to surely decrease cogging torque, and it is possible to obtain the sufficient amount of magnetic flux. Thereby, it is possible to achieve sure realization of low vibration and realization of high output of the motor 101.

In the case where the magnets each have a flat plate shape, it is easy and common that the magnet is magnetized so as to generate magnetic flux in the direction vertical to the surface of the magnet. Thereby, the magnet is extended in the circumferential direction of the yoke, as the neighboring magnets approach each other, that is, as the θ2 approaches 60 degrees, the magnetic fluxes of the neighboring magnets in the outer side overlap with each other. As a result, cogging torque, or one of the vibration generation factors, increases conversely.

Accordingly, it is conceivable that the magnets are magnetized such that the magnetic flux extends toward the center axis of the DC motor in any part of the surface of the magnets, so that the magnetic fluxes on the outer side of neighboring magnets do not overlap each other. In this case, it is necessary for the magnets to be magnetized such that the magnetic flux extends toward the center part of the magnet toward the outer side from the center part of the yoke so that magnetization of the magnets becomes complicated.

The magnets are used that each have a flat plate shape and are magnetized such that the magnetic flux extends in the direction perpendicular to the surface. When the magnets are formed in such a way that the dimension in the circumferential direction of the yoke becomes sufficiently small, it is possible to prevent the magnetic fluxes of the outer side of the neighboring magnets from overlapping each other. However, it is unclear whether cogging torque surely decreases by this means. Further, since the dimension of the magnets is formed to be small, the amount of magnetic flux becomes small, and there is concern that the motor output may decrease.

That is, in the case where the magnets having such a flat plate shape are used, it is unclear how long each magnet should be formed in the width direction, and it is desired that the length of the width direction of each magnet be set to a preferable value.

On the contrary, in the present embodiment, it is possible to surely decrease cogging torque, or one of the vibration generation factors, while using magnets having a flat plate shape to generate magnetic flux extending in a direction perpendicular to the surface of the armature.

(6) In the present embodiment, the yoke 104 has a hexagonal cylindrical shape, and the magnets 1105 are fixed on the respective flat surfaces of the inner wall surface. For that reason, the magnets 1105 are fixed easily. Further, the shape of the yoke 104 is simple, thereby forming the yoke is easy, and since the outer circumferential surface of the yoke has the flat surface, the motor 101 is installed easily.

The above described respective embodiments may be modified as follows:

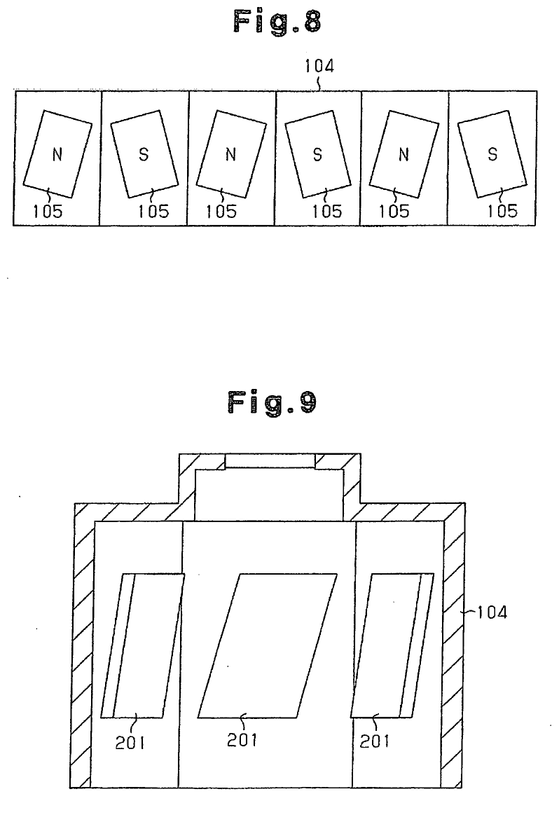

In the first embodiment, the permanent magnets 105 are arranged such that the respective sides of the surface 105a are inclined at the same tilt angle relative to the axial direction of the yoke 104, and the whole permanent magnets 105 are inclined in the same direction. However, not limited to this, as shown in FIG. 8, the respective sides of the surface 105a are inclined with the same angle relative to the axial direction of the yoke 104, and the neighboring permanent magnets 105 may be arranged in the direction opposite to each other. In this case, for instance, at the time of rotation of the armature 103, balance of the force added to the armature 103 along the axial direction of the yoke 104 becomes favorable.

In the first embodiment, the permanent magnets 105 configured such that the surface 105a has the rectangle shape and the respective sides of the surface 105a are arranged in such a way as to be inclined relative to the axis of the yoke 104. However, not limited to this, if the dimension Y of the permanent magnets 105 decreases toward the outer side from the center part of the respective permanent magnets 105, the shape of the permanent magnet 105 may be modified.

For instance, as shown in FIG. 9, the surface of the permanent magnets 201 may have a parallelogram shape provided with two pairs of sides with different lengths. That is, the permanent magnet 201 may be configured as a parallelogram plate. In this case, the permanent magnet 201 is configured such that one (short side) group of two facing sides extends along a direction perpendicular to the axis of the yoke 104 and other (long side) group of two facing sides is arranged in such a way as to be inclined relative to the axis of the yoke 104. In this case, also it is possible to further decrease cogging torque. The permanent magnet 201 may be rotated on the flat surface of the inner wall surface of the yoke 104 in the same way as the permanent magnet 105 according to the first embodiment.

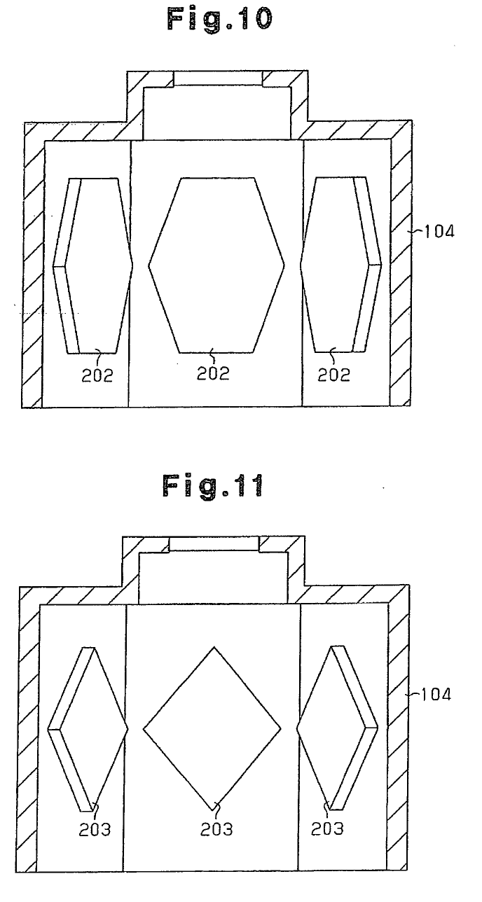

For instance, as shown in FIG. 10, the surface of the permanent magnet 202 may have a hexagonal shape. That is, the permanent magnet 202 may be configured in the shape of the hexagonal plate. In this case, the permanent magnet 202 is configured such that the one group of two facing sides is arranged in such a way as to extend along a direction perpendicular to the axis of the yoke 104. Also, in this case, it is possible to further decrease cogging torque. The permanent magnet 202 may be rotated on the flat surface of the inner wall surface of the yoke 104 in the same way as the permanent magnet 105 in the first embodiment.

For instance, as shown in FIG. 11, the surface of the permanent magnet 203 against the armature 103 may have a rhombus shape. That is, the permanent magnet 203 may be configured in the shape of a rhombus plate. In this case, the permanent magnet 203 is configured such that one (short) diagonal line is arranged in such a way as to extend along a direction perpendicular to the axial direction of the yoke 104 and the other (long) diagonal line is arranged in such a way as to extend along the axis of the yoke 104. Also, in this case, it is possible to further decrease cogging torque. The permanent magnet 203 may be rotated on the flat surface of the inner wall surface of the yoke 104 in the same way as the permanent magnet 105 in the first embodiment.

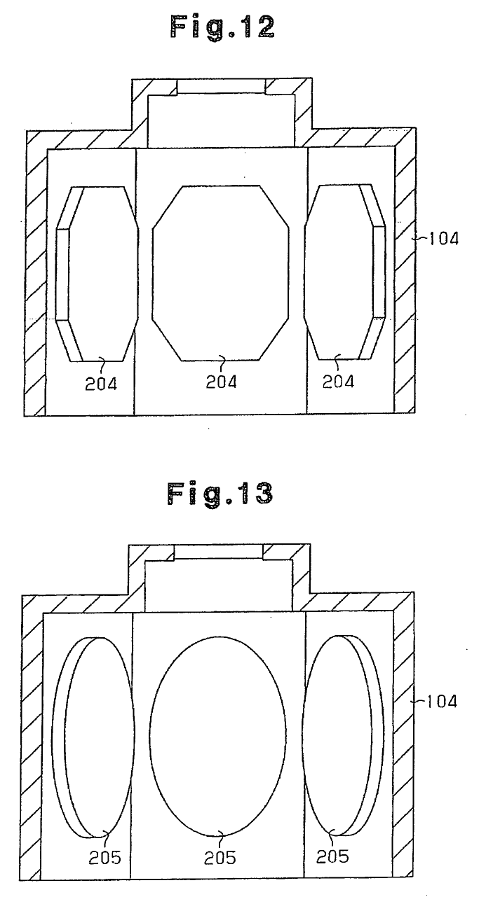

For instance, as shown in FIG. 12, the surface of the permanent magnet 204 may have an octagon shape. That is, the permanent magnet 204 may be configured in the shape of the octagonal plate. In this case, the permanent magnet 204 is configured such that one group of two facing sides is arranged in such a way as to extend along the axis of the yoke 104 and the other group of two facing sides arranged in such a way as to extend along a direction perpendicular to the axis of the yoke 104. Also, in this case, it is possible to further decrease cogging torque. The permanent magnet 204 may be rotated on the flat surface of the inner wall surface of the yoke 104 in the same way as the permanent magnet 105 in the first embodiment.

For instance, as shown in FIG. 13, the surface of the permanent magnet 205 may have an oval shape. That is, the permanent magnet 205 may be configured in the shape of the oval plate. In this case, the permanent magnet 205 is configured such that the minor axis is arranged in such a way as to extend along a direction perpendicular to the axis of the yoke 104 and the major axis is arranged in such a way as to extend along the axial direction of the yoke 104. Also, in this case, it is possible to further decrease cogging torque. The permanent magnet 205 may be rotated on the flat surface of the inner wall surface of the yoke 104 in the same way as the permanent magnet 105 in the first embodiment.

In the first embodiment, the yoke 104 has a hexagonal cylindrical shape and six permanent magnets 105 fixed on the flat surface of the inner wall surface of the yoke 104 at equiangular intervals. However, not limited to this, the yoke 104 may have a polygonal cylindrical shape other than the hexagonal cylindrical shape. Then, the number of permanent magnets 105 may be modified in accordance with the number of flat surfaces on the inner wall surfaces of the yoke 104. In this case, it is necessary for the open angle 01 of the permanent magnets 105 to be set to a value by which at least all permanent magnets 105 are capable of being juxtaposed in the circumferential direction of the yoke 104.

The open angle θ1 of the permanent magnets 105 may be set to, for instance, not less than 34.5 degrees and less than 44 degrees, and exceeding 46.5 degrees and not more than 52 degrees. Also, in this case, as shown in FIG. 4, in comparison with the case in which the open angle θ1 of the permanent magnets 105 is 60 degrees where the permanent magnets 105 are arranged in the circumferential direction of the yoke 104 without any gap, it is possible to decrease cogging torque.

The manufacturing method for the DC motor 101 in the first embodiment is provided with “the temporary fixing process”, “the measuring process”, “the adjusting process” and “the fixing process”. However, not limited to this, the DC motor 101 may be manufactured with an other method. For instance, “the temporary fixing process”, “the measuring process” and “the adjusting process” may be omitted, and the respective permanent magnets 105 may be fixed on the respective flat surfaces of the inner wall surface of the yoke 104 with the adhesive in such a way as to have the tilt angle designed preliminarily.

In the first embodiment, the permanent magnets 105 are formed with neodymium magnets. However, not limited to this, the permanent magnets 105 may be formed with magnets other than neodymium magnets such as ferrite magnets or the like. Similarly, also, the magnets 1105 in the second embodiment may be formed with magnets other than neodymium magnets such as ferrite magnets or the like.

In the second embodiment, the yoke 104 has a hexagonal cylindrical shape. However, not limited to this, the yoke 104 may have a polygonal cylindrical shape other than a hexagonal cylindrical shape. For instance, the yoke 104 may have a dodecagonal cylindrical shape. On the inner wall surfaces of the yoke 104, a flat surface having a width equal to a length of the width direction of the magnet 1105 may be formed on every other one. The magnet 1105 is fixed on a flat surface having a width equal to the length of its width direction. In this case, when the magnet 1105 is fixed on the flat surface, the magnet 1105 comes into contact with a flat surface positioned between one pair of flat surfaces having the width equal to the length of the width direction of the magnet 1105, thereby, it is possible to perform positioning of the magnet 1105 easily.

In the second embodiment, as shown in FIG. 5, the thickness of the yoke 104 is set uniformly in the circumferential direction of the yoke 104. However, not limited to this, in the yoke 104, for instance, portions corresponding to the respective flat surfaces on which the magnets 105 are fixed may be formed thickly and portions corresponding to corners of the yoke 104 may be formed thinly.

In the second embodiment, in the commutator 108, the segments arranged in 120 degrees interval are short circuited and in the same potential. One pair of the power supply brushes 109a, 109b are arranged to the respective segments being in the same potential. However, not limited to this, the number of the power supply brushes may be changed appropriately. In the second embodiment, the number of the power supply brushes is up to three groups. In the case where three groups of power supply brushes are arranged, since it is not necessary for the segment to perform short-circuiting, it is possible to omit members with respect to the short-circuiting. Further, the respective power supply brushes 109a, 109b may be arranged at an angular interval other than 120 degrees.

1. A DC motor comprising:
a yoke having a polygonal cylindrical shape and having an inner wall surface provided with a plurality of consecutive flat surfaces;
a plurality of permanent magnets each having a flat plate shape and fixed on the respective flat surfaces in the inner wall surface of the yoke; and
an armature arranged rotatably within the yoke,
wherein a dimension of each magnet along an axial direction of the yoke decreases toward an outer side from a center part of the permanent magnet.

2. A DC motor comprising:
a yoke having a polygonal cylindrical shape and having an inner wall surface provided with a plurality of consecutive flat surfaces;
an armature arranged rotatably within the yoke; and
a plurality of permanent magnets each having a flat plate shape and fixed on the respective flat surfaces in the inner wall surface of the yoke, wherein each permanent magnet has a surface facing the armature, and the surface has a polygonal shape provided with a symmetry center or an oval shape,
wherein each of the permanent magnets is asymmetrical with respect to a line passing through the symmetry center and extending in an axial direction of the yoke.

3. The DC motor according to claim 2,
wherein the surface of each permanent magnet has a rectangle shape provided with four sides; and
wherein each permanent magnet has a fixed surface fixed to the inner surface of the yoke and has an N pole or an S pole on the fixed surface and the surface, the permanent magnets being arranged such that the surfaces of each neighboring pair of the permanent magnets are different, and each side of the surfaces is inclined relative to the axis of the yoke at a same tilt angle, and each neighboring pair of the permanent magnets are arranged in such a way as to be inclined in opposite directions.

4. The DC motor according to claim 2,
wherein the DC motor is provided with a center axis,
wherein the yoke has a hexagonal cylindrical shape,
wherein six pieces of the permanent magnets are fixed on the inner wall surface of the yoke at equiangular intervals,
wherein the surface of each permanent magnet has a rectangular shape provided with four sides,
wherein each permanent magnet is configured such that each side of the surface is arranged in such a way as to be inclined relative to the axial direction of the yoke, and
wherein, on the surface of each permanent magnet, an angle constituted by a pair of line segments connecting both ends in a direction perpendicular to the axis of the yoke to the center axis is set in a range from 34.5 degrees to 52 degrees.

5. The DC motor according to claim 4, wherein the angle is set in a range from 35.5 degrees to 52 degrees.

6. The DC motor according to claim 5, wherein the angle is set in a range from 40 degrees to 52 degrees.

7. The DC motor according to claim 6, wherein the angle is set in a range from 44 degrees to 46.5 degrees.

8. A method for manufacturing a DC motor, wherein the DC motor comprises a yoke having a polygonal cylindrical shape and having an inner wall surface provided with a plurality of consecutive flat surfaces, an armature arranged rotatably within the yoke, and a plurality of permanent magnets each having a flat plate shape fixed on respective flat surfaces on the inner wall surface of the yoke, wherein each permanent magnet has a surface facing the armature, and the surface has a polygonal shape provided with a symmetry center or an oval shape, wherein each permanent magnet is asymmetrical with respect to a line passing through the symmetry center and extending in an axial direction of the yoke, the method comprising:
fixing temporarily each of the permanent magnets on each flat surface on an inner wall surface of the yoke due to magnetic attraction from each magnet;
measuring motor characteristics including cogging torque;
rotating the permanent magnets with the symmetry center as a rotation center on the flat surface on the inner wall surface of the yoke when motor characteristics as measured are deviate from a value set preliminarily; and
fixing each of the permanent magnets on each of the flat surfaces in the inner wall surface of the yoke with an adhesive.

9. A DC motor comprising:
a yoke having a cylindrical shape and an inner wall surface;
an armature arranged inside the yoke, including
an armature core having a cylindrical shape comprising an outer circumferential surface, and eight teeth radially extending from the outer circumferential surface;
a commutator comprising twenty-four segments, the commutator being arranged on an inner side of the armature core; and
eight coils wound around the respective teeth with concentrated-winding, each coil being connected to at least one of the segments, wherein the coils are connected in such a way as to form one closed loop;
an anode side power supply brush and a cathode side power supply brush each coming into a slidable contact with at least one of the segments of the commutator, the brushes causing the armature to rotate by supplying drive supply power for the armature through the commutator;
a plurality of magnets each having a flat plate shape, being set on the inner wall surface of the yoke at equiangular intervals, wherein each magnet includes:
a surface facing the armature; and
a magnetic flux extending in a direction perpendicular to the surface; and
a center axis,
wherein, on the surface of each magnet, an angle formed by a pair of line segments connecting both ends in a direction perpendicular to the axial direction of the yoke to the center axis is set in a range from 34.5 degrees to 52 degrees.

10. The DC motor according to claim 9, wherein the angle is set in a range from 35.5 degrees to 52 degrees.

11. The DC motor according to claim 10, wherein the angle is set in a range from 40 degrees to 52 degrees.

12. The DC motor according to claim 11, wherein the angle is set in a range from 44 degrees to 46.5 degrees.

13. The DC motor according to claim 9,
wherein the yoke has a polygonal cylindrical shape,
wherein the inner wall surface is provided with a plurality of consecutive flat surfaces, and
wherein each magnet is fixed on one of the flat surfaces on the inner wall surface of the yoke.
